(19) United States
(12) Patent Application Publication
(10) Pub. No.: US 2019/0265874 A1
(43) Pub. Date: Aug. 29, 2019

(54) PANEL CONTROL SYSTEM AND EDITING METHOD THEREOF

(71) Applicant: WINSTAR DISPLAY CO., LTD., Taichung City (TW)

(72) Inventors: YU-PIN LIAO, Taichung City (TW); CHIA-HUI CHEN, Taichung City (TW); CHIEN-MING CHEN, Taichung City (TW); WEN-WEI CHUNG, Taichung City (TW); FUN-CHU LAI, Taichung City (TW); YUNG-CHANG HSU, Taichung City (TW); KUAN-CHUAN LIAO, Taichung City (TW)

(21) Appl. No.: 16/278,097

(22) Filed: Feb. 16, 2019

(30) Foreign Application Priority Data
Feb. 26, 2018 (TW) 107106451

(51) Int. Cl. G06F 3/0484; G06F 3/0481; G06F 3/0486

(52) U.S. Cl. CPC G06F 3/04847; G06F 3/0488; G06F 3/0486; G06F 3/0481

(57) ABSTRACT

The present disclosure relates to a panel control system and an editing method thereof. The panel control system includes a display panel and a processing device connected to the display panel. The processing device includes a graphical user interface (GUI) program, including an interface element window which includes a plurality of interface elements, and an interface editing window connected to the interface element window. Each of the interface elements includes an element command window, an element parameter window, and an element attribute window. The element command window includes a plurality of original element commands. The plurality of the original element commands are dragged to the element parameter window to form a plurality of element parameter commands. The element attribute window includes a plurality of element attribute commands.

### TECHNICAL FIELD

The present disclosure relates to a panel control system and an editing method thereof, more particularly to a panel control system which may be edited by a graphical user interface (GUI).

### DESCRIPTION OF THE RELATED ART

In programming process, a graphical user interface (GUI) is usually implemented by using an application program interface (API) provided by an operation system, and it usually cooperates with a variety of auxiliary text of the programming languages. The conventional GUI program is configured to combine the attributes of the GUI and multiple programming languages, with the program itself. This may reduce the efficiency and the readability of the program, and the program may be difficult to maintain.

For example, when the program has been edited, any further modification of the GUI or the auxiliary text of the programming language requires to recompile the program, which is inconvenient. However, the APIs provided by the different operation systems are different, and the GUI programming code applicable to one operation system may not be applicable to anther operation system. Moreover, the edition of the GUI may require to activate multiple applications. The syntax of each of the multiple programming languages are different, and the users may need to memorize plenty of text commands, which may cause a syntactic error for the users.

Therefore, it is necessary to provide an editing method of the GUI of the panel control system to simplify the syntax of the commands.

### SUMMARY

The present disclosure relates to a panel control system, wherein the system is edited by graphical interface.

In one aspect, the present disclosure relates to a panel control system, including: a display panel, a processing device connected to the display panel. The processing device includes a graphical user interface (GUI) program including: an interface element window including a plurality of interface elements. An interface editing window connected to the interface element window. The interface editing window is configured to edit the plurality of the interface elements. Each of the interface elements includes an element command window, an element parameter window, and an element attribute window. The element command window includes a plurality of original element commands. The plurality of the original element commands are dragged to the element parameter window to form a plurality of element parameter commands. The element attribute window includes a plurality of element attribute commands.

In another aspect, the present disclosure relates to an editing method of the panel control system, including: initiating the processing device and operating the GUI program, dragging the at least one interface element from the interface element window to the interface editing window, selecting the at least one interface element from the interface editing window and dragging the plurality of the original element commands from the element command window to the element parameter window to form the plurality of the element parameter commands, selecting the at least one interface element from the interface editing window and editing the plurality of the element attribute commands of the at least one interface element in the element attribute window, and displaying window images of the interface editing window on the display panel.

The above summary is to provide a basic description of several aspects and features of the present disclosure. The summary is not a detailed description of the present disclosure, and its purpose is not to specifically list key or important elements of the present disclosure, nor to refine the scope of the present disclosure. The summary merely presents several concepts of the present disclosure in a simplified form.

### BRIEF DESCRIPTION OF THE DRAWINGS

FIG. 1 is a diagram illustrating a panel control system in accordance with one embodiment of the present disclosure.

FIG. 2 is a diagram illustrating a graphical user interface (GUI) program in accordance with one embodiment of the present disclosure.

FIG. 3 is a diagram illustrating a display panel in accordance with one embodiment of the present disclosure.

FIG. 4 is a diagram illustrating a display panel displaying graphical images in accordance with one embodiment of the present disclosure.

FIG. 5 is a flowchart illustrating an editing method of a panel control system in accordance with one embodiment of the present disclosure.

### DESCRIPTION OF THE PREFERRED EMBODIMENTS

To clarify the purpose, technical solutions, and the advantages of the disclosure, embodiments of the present disclosure will now be described more fully hereinafter with reference to the accompanying drawings.

The present disclosure relates to a panel control system and an editing method thereof. By combining all of applications within one window and cooperating with a graphical editing interface, the inconvenience resulting from operating different compiling procedures may be eliminated.

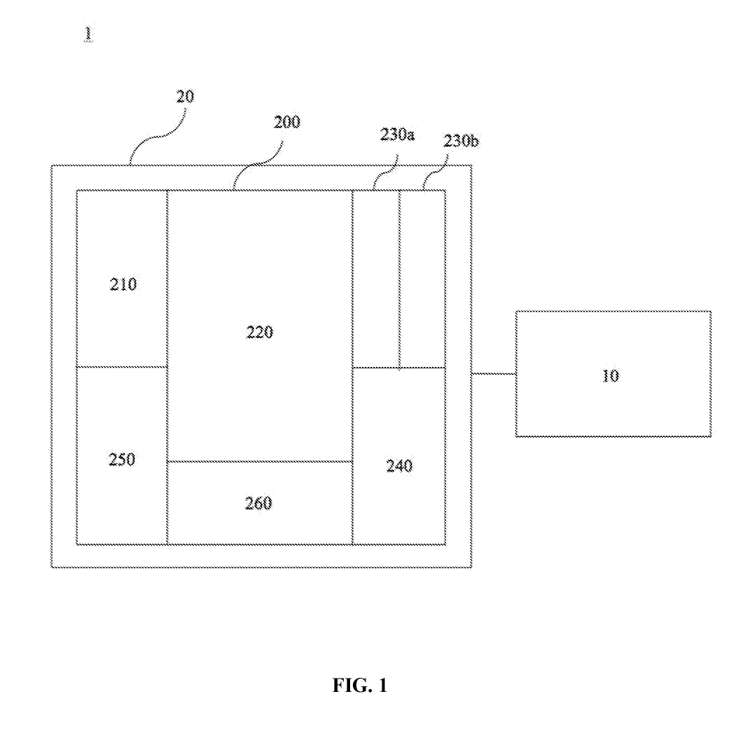

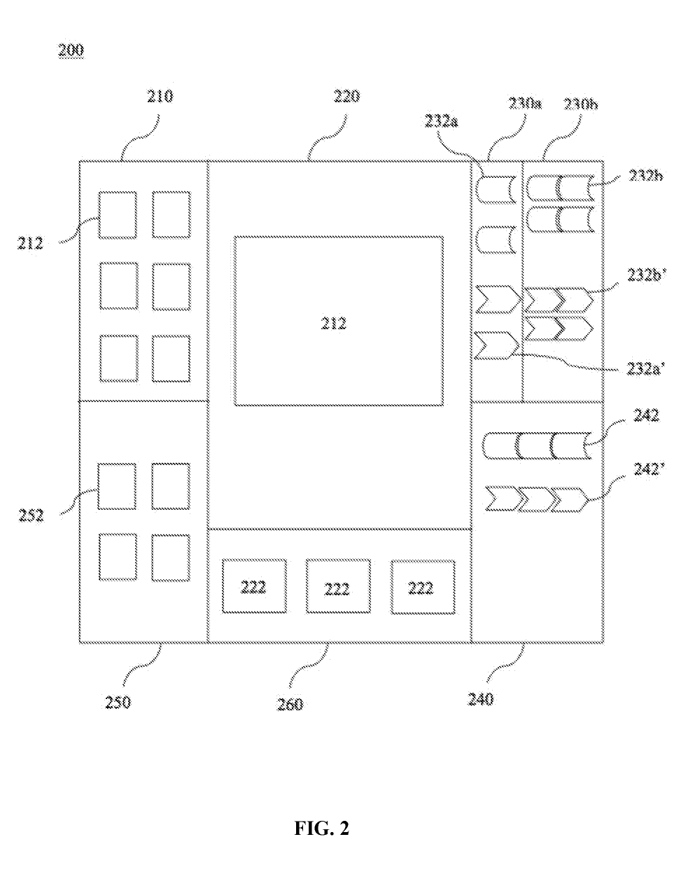

Referring to FIG. 1, the present disclosure relates to a panel control system 1, including: a display panel 10 and a processing device 20 (e.g. processor) connected to the display panel 10. The processing device 20 includes a graphical user interface (GUI) program 200. The GUI program 200 includes: an interface element window 210 and an interface editing window 220. The interface element window 210 includes a plurality of interface elements 212 (shown in FIG. 2). The interface editing window 220 is connected to the interface element window 210, and the interface editing window 220 is configured to edit the plurality of the interface elements 212. Each of the interface elements 212 includes an element command window 230a, an element parameter window 230b, and an element attribute window 240. The element command window 230a includes a plurality of original element commands 232a (shown in FIG. 2), and the plurality of the original element commands 232a may be dragged to the element parameter window 230b by users to form a plurality of element parameter commands 232b (shown in FIG. 2). The element attribute window 240 includes a plurality of element attribute commands 242.

The GUI program 200 may further include an external interface element window 250 and an edition-displaying window 260. The external interface element window 250 is configured to load at least one external interface element 252 (shown in FIG. 2). The edition-displaying window 260 is configured to display at least one shrinking interface editing window 222 (shown in FIG. 2).

In one example, the display panel 10 may be a thin film transistor liquid crystal display (TFT-LCD) or an organic light-emitting diodes (OLED) display cooperating with a control panel and a resistor-type/capacitor-type touch panel. A size of the display panel 10 may be in a range from 2 to 15 inches. The display panel 10 may be adopted in industrial equipment, medical equipment, GPS navigators, coffee machines, washing machines, energy systems, charging piles, POS (point of sales) systems, vending machines, and parking fee machines.

In one example, the processing device 20 may be mobile devices, desktops, laptops, personal digital assistant (PDA), video game consoles, or other embedded hosts.

In one example, referring to FIG. 2, the graphical interface program 200 may include: the interface element window 210, the interface editing window 220, the element command window 230a, the element parameter window 230b, the element attribute window 240, the external interface element window 250, and the edition-displaying window 260 presented in a single graphical interface, so as to improve development of the GUI program 200.

The interface element window 210 may include the plurality of the interface elements 212. The plurality of the interface elements 212 may be predetermined numbers (such as 0, 10, 20, and 30), predetermined text (such as speed, blood pressure, and pulse), or predetermined images (such as speedometer of automotive, pulse line chart, switch images, and clock images). The users may drag the at least one interface element 212 to the interface editing window 220 to edit the at least one interface element 212 according to actual demands.

When the users desire to adopt external text, external numbers, or external images, the at least one external interface element 252 may be loaded via the external interface element window 250. The users may drag the at least one external interface element 252 to the interface editing window 220 to edit the at least one external interface element 252.

The users may drag the at least one external interface element 252 or the at least one interface element 212 to any places of the interface editing window 220 according to the actual demands. The users may select the at least one interface element 212 in the interface editing window 220, and may edit the plurality of the original element commands 232a of the at least one interface element 212 in the element command window 230a. The plurality of the original element commands 232a may be edited by dragging the plurality of the original element commands 232a to the element parameter window 230b to form the plurality of the element parameter commands 232b. The users may also select the at least one interface element 212 in the interface editing window 220, and may edit the plurality of the element attribute commands 242 of the at least one interface element 212 in the element attribute window 240.

Similarly, the users may select the at least one external interface element 252 in the interface editing window 220, and may edit the plurality of the external original element commands 232a′ of the at least one external interface element 252 in the element command window 230a. The external original commands 232a′ may be edited by dragging the external original element commands 232a′ to the element parameter window 230b to form the plurality of the external element parameter commands 232b′. The users may also select the at least one external interface element 252 in the interface editing window 220, and may edit the plurality of the external element attribute commands 242′ of the at least one external interface element 252 in the element attribute window 240.

In one example, editions of the plurality of the element attribute commands 242 in the element attribute window 240 may include a size of the selected at least one interface element 212, a color of the selected at least one interface element 212, and a font of the selected at least one interface element 212. The above size, color, and font may be edited in a form of selecting or a drop-down menu. That is, all parameters of the element attribute window 240 may be programmed without inputting text, so as to avoid human errors. Similarly, the editions of the plurality of the external attribute commands 242′ in the element attribute window 240 may include a size of the selected at least one external interface element 252, a color of the selected at least one external interface element 252, and a font of the selected at least one external interface element 252. The above size, color, and font may be edited in the form of selecting or the drop-down menu.

In one example, the edited original element commands 232a in the element commands window 230a may be the original element commands 232a, i.e., conventional programming code, of the selected at least one interface element 212. The plurality of the original element commands 232a may be edited by dragging the plurality of the original element commands 232a to the element parameter window 230b to form the plurality of the element parameter commands 232b. It is noted that the plurality of the original element commands 232a, the plurality of the element parameter commands 232b, and the plurality of the element attribute commands 242 are configured to be a graphical puzzle formed by at least one programming code logic. The graphical puzzle may be distinguished by different colors. That is, a shape and a color of the graphical puzzle corresponding to different functions and parameters may be different. A connecting relation between each the element parameter command 232b requires to mate with a suitable graphical puzzle, and window images of the interface editing window 220 may be transmitted to the display panel 10.

Similarly, the edited external original element commands 232a′ in the element commands window 230a may be the external original element commands 232a′, i.e., the conventional programming code, of the selected at least one external interface element 252. The plurality of the external original element commands 232a′ may be edited by dragging the plurality of the external original element commands 232a′ to the element parameter window 230b to form the plurality of the external element parameter commands 232b′. It is noted that the plurality of the external original element commands 232a′, the plurality of the external element parameter commands 232b′, and the plurality of the external element attribute commands 242′ are configured to be the graphical puzzle formed by the at least one programming code logic. The graphical puzzle may be distinguished by different colors. That is, the shape and the color of the graphical puzzle corresponding to different functions and parameters may be different. A connecting relation between each external element parameter command 232b′ requires to mate with the suitable graphical puzzle, and the window images of the interface editing window 220 may be transmitted to the display panel 10. By mating the shape and the color of the graphical puzzle, the users may not need to memorize complicated text commands, so as to avoid errors.

In one example, the GUI program 200 may further include a command debugging module (not shown) configured to detect errors of the logical syntax of the plurality of the element parameter commands 232b in the element parameter window 230b or the plurality of the external element parameter commands 232b′, that is, to detect whether there is any graphical puzzle of the plurality of the element parameter commands 232b or the plurality of the external parameter commands 232b′ does not mate to another graphical puzzle. The command debugging module is further configured to show the element parameter commands 232b or the external parameter commands 232b′ having the suitable shape of the graphical puzzle for the users' reference.

All of the interface editing windows 222 in used are displayed with a condensed size in the edition-displaying window 260. When the users open at least two interface editing windows 220 to edit the images, the edition-displaying window 260 is configured of display all of the shrinking interface editing windows 222. It is convenient for the users to switch the interface editing windows 220 for editing.

In one example, the GUI program 200 may further include a data structure (not shown) configured to store the plurality of the original element commands 232a, the plurality of the element parameter commands 232b, and the plurality of the element attribute commands 242 built in the GUI program 200. The data structure is further configured to store the plurality of the external original element commands 232a′, the plurality of the external element parameter commands 232b′, and the plurality of the external element attribute commands 242′. When the users need to use the similar commands or parameters, the users may directly select the related the commands or parameters from the data structure. The data structure may be a tree-data structure, and the tree-data structure may be a folder or a database.

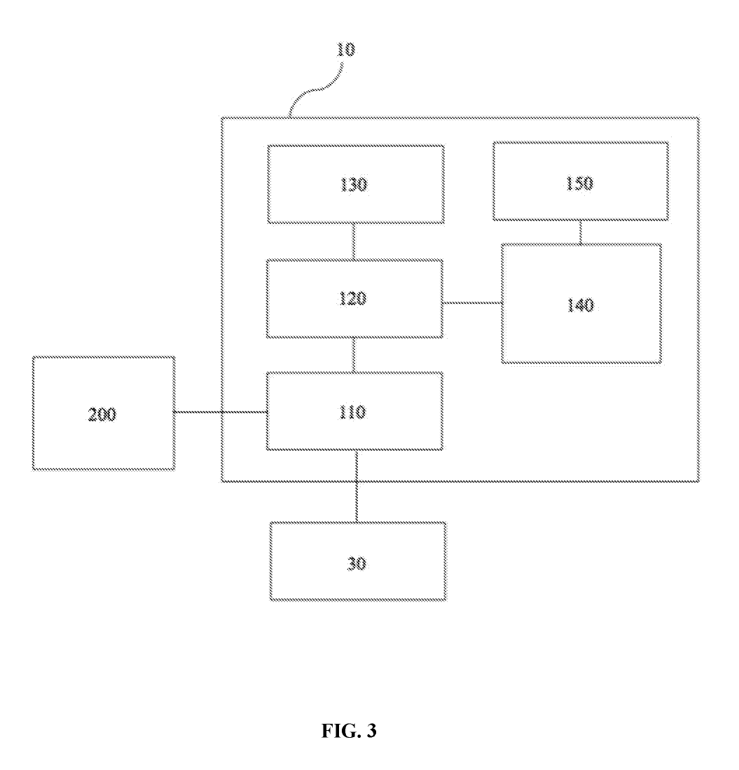

Referring to FIG. 3, the display panel 10 may further include a communication unit 110, a graphical processing unit 120, a memory unit 130, a display unit 140, and a power control unit 150.

In one example, the communication unit 110 is connected to the GUI program 200. The communication unit 110 is configured to receive a resource file transmitted from the GUI program 200. The resource file may include the original element commands 232a, the element parameter commands 232b, and the element attribute commands 242 of each interface element 212 in the interface editing window 220. The resource file may also include the external original element commands 232a′, the external parameter commands 232b′, and the external attribute commands 242′ of each external interface element 252 in the interface editing window 220. In another example, the communication unit 110 may further connect with other external devices 30, and the users may be able to remotely control the display panel 10. Connection between the communication unit 110 and the external devices 30 may not be limited to a wired connection or a remote wireless connection.

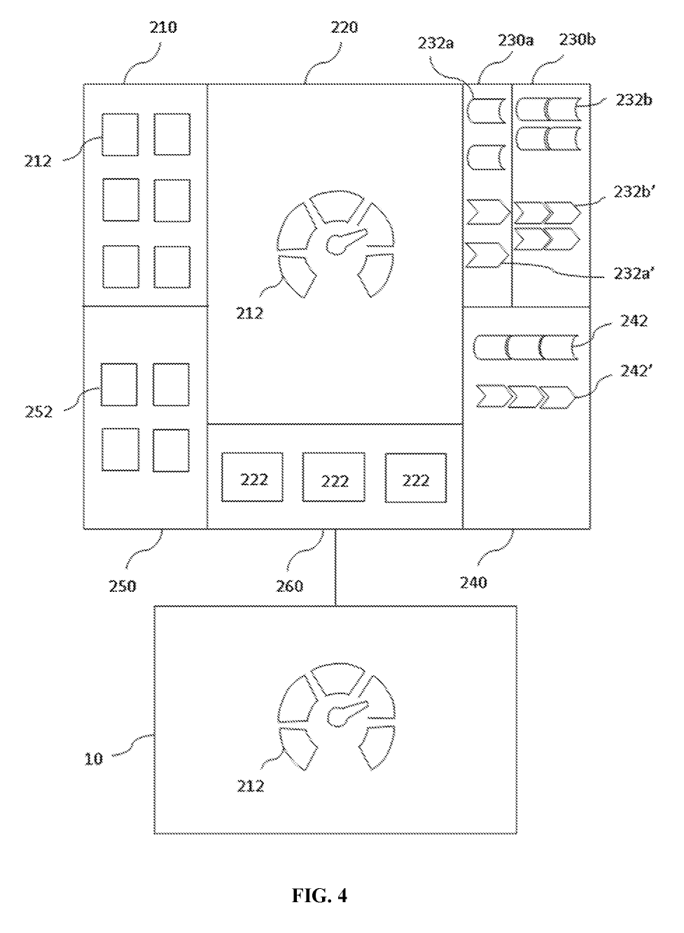

The graphical processing unit 120 is connected to the communication unit 110. The graphical processing unit 120 is configured to receive and process the resource file. The graphical processing unit 120 is configured to transform the element parameter commands 232b and the element attribute commands 242 of each the interface element 212, and the external element parameter commands 232b′ and the external element attribute commands 242′ of each of the external interface elements 252 into a graphical image. The graphical processing unit 120 is further configured to transmit the graphical image to the display unit 140. Referring to FIG. 4, in one example, the display unit 140 is configured to receive and display the graphical image. The graphical image is the same with the window image of the interface editing window 220 in the GUI program 200. The graphical image may include images of each interface element 212 and the external interface element 252 in the interface editing window 220. In one example, the display unit 140 may be the TFT-LCD or the OLED display.

The memory unit 130 is connected to the graphical processing unit 120. The memory unit 120 is configured to store the resource file and the graphical images. When the graphical processing unit 120 receives the same resource file, the memory unit 130 is configured to transform the resource file into the corresponding graphical image instantly. As such, the graphical processing unit 120 may not require to re-process the resource file, and processing time may be saved. The power control unit 150 is connected to the display unit 140. The power control unit 150 is configured to turn on or turn off the display panel 10.

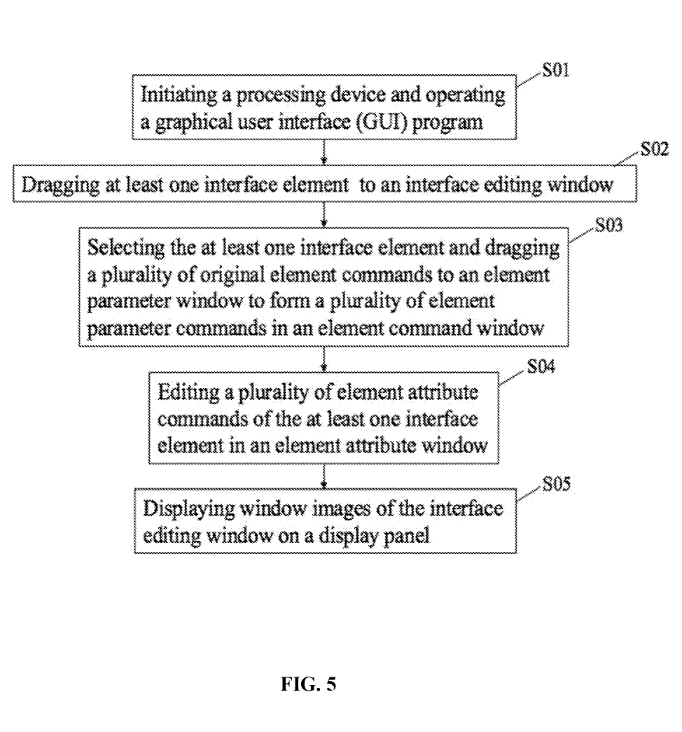

Referring to FIG. 5, the present disclosure further relates to an editing method of the panel control system, including the following steps.

In step S01, initiating the processing device and operating the GUI program 200.

In step S02, dragging the at least one interface element 212 from the interface element window 210 to the interface editing window 220.

In step S03, selecting the at least one interface element 212 from the interface editing window 220 and dragging the plurality of the original element commands 232a from the element command window 230a to the element parameter window 230b to form the plurality of the element parameter commands 232b.

In step S04, selecting the at least one interface element 212 from the interface editing window 220 and editing the plurality of the element attribute commands 242 of the at least one interface element 212 in the element attribute window 240.

In step S05, displaying the window images of the interface editing window 220 on the display panel 10.

In the steps S02 to S04, the users may drag the at least one external interface element 252 loaded from the external interface element window 250 to the interface editing window 220. In one example, the users may select the at least one external interface element 252 in the interface editing window 220, and may drag the plurality of the external original element commands 232a′ from the element command window 230a to the element parameter window 230b to form the plurality of the external element parameter commands 232b′. The users also may select the at least one external interface element 252 in the interface editing window 220, and may edit the plurality of the external element attribute commands 242′ of the at least one external interface element 252 in the element attribute window 240.

In view of the above, the graphical interfaces of the panel control system (which includes the interface element window including the plurality of the interface elements, the external interface element loaded from the external interface element window, and the plurality of the element commands and the element parameter of the element command window) of the present disclosure are all presented in form of images. Especially, the logic of the syntactic connection is presented by the shapes and the colors of the graphical puzzle of the plurality of the element commands and the plurality of the element parameters. As such, the users may not require to memorize the additional text commands, the error may be avoided, and the syntax may be simplified.

The above description is merely the embodiments in the present disclosure, the claim is not limited to the description thereby. The equivalent structure or changing of the process of the content of the description and the figures, or to implement to other technical field directly or indirectly should be included in the claim. All other embodiments obtained by a person of ordinary skill in the art based on the embodiments of the present disclosure without creative efforts shall fall within the protection scope of the present disclosure.

What is claimed is:

1. A panel control system, comprising:
a display panel;
a processing device connected to the display panel, wherein the processing device comprises a graphical user interface (GUI) program comprising:
an interface element window comprising a plurality of interface elements; and
an interface editing window connected to the interface element window, wherein the interface editing window is configured to edit the plurality of the interface elements;
wherein each of the interface elements comprises an element command window, an element parameter window, and an element attribute window, the element command window comprises a plurality of original element commands, the plurality of the original element commands are dragged to the element parameter window to form a plurality of element parameter commands, and the element attribute window comprises a plurality of element attribute commands.

2. The panel control system according to claim 1, wherein the GUI program further comprises an external interface element window configured to load at least one external interface element.

3. The panel control system according to claim 1, wherein the GUI program further comprises an edition-displaying window configured to display at least one shrinking interface editing window.

4. The panel control system according to claim 1, wherein the plurality of the original element commands, the plurality of the element parameter commands, and the plurality of the element attribute commands are configured to be a graphical puzzle formed by at least one code logic.

5. The panel control system according to claim 1, wherein the GUI program further comprises a command debugging module configured to detect the plurality of the element parameter commands in the element parameter window.

6. The panel control system according to claim 1, wherein the GUI program further comprises a data structure configured to store the plurality of the original element commands, the plurality of the element parameter commands, and the plurality of the element attributes.

7. The panel control system according to claim 1, wherein the display panel further a communication unit, a graphical processing unit, a memory unit, a display unit, and a power control unit.

8. The panel control system according to claim 7, wherein the display panel is a touch panel.

9. The panel control system according to claim 7, wherein the display panel is a thin film transistor liquid crystal display (TFT-LCD) or an organic light-emitting diodes (OLED) display.

10. An editing method of the panel control system according to claim 1, comprising:
initiating the processing device and operating the GUI program;
dragging the at least one interface element from the interface element window to the interface editing window;
selecting the at least one interface element from the interface editing window and dragging the plurality of the original element commands from the element command window to the element parameter window to form the plurality of the element parameter commands;
selecting the at least one interface element from the interface editing window and editing the plurality of the element attribute commands of the at least one interface element in the element attribute window; and
displaying window images of the interface editing window on the display panel.
